(19) United States
(12) Patent Application Publication
(10) Pub. No.: US 2004/0078401 A1
(43) Pub. Date: Apr. 22, 2004

(54) Bias-free rounding in digital signal processing

(76) Inventor: Howard E. Hilton, Snohomish, WA (US)

Correspondence Address: AGILENT TECHNOOLOGIES, INC., Intellectual Property Administration, Legal Department, DL429, P.O. Box 7599, Loveland, CO, 80537-0599, US

(21) Appl. No.: 10/277,419

(22) Filed: Oct. 22, 2002

(51) Int. Cl. G06F 1/02

(52) U.S. Cl. 708/252

(57) ABSTRACT

Nondeterministic rounding of fixed point values in a digital signal processor. A pseud-random value is generated and a preselcted number of pseudo-random bits are added to the result to be rounded prior to truncation being applied. Pseudo-random numbers may be generated by means including two maximal-length pseudo-random sequence generators.

### BACKGROUND OF THE INVENTION

1. Field of the Invention

The present invention pertains to the art of signal processing using Digital Signal Processors (DSPs). More particularly, the application deals with converting a fixed-point high resolution value to a lower resolution value, such as in converting a fixed-point value from a wider to a narrower word width.

2. Art Background

Digital signal processing (DSP) systems ultimately must contend with the effects of finite word width. This is true even when the DSP provides floating point numeric formats for calculations. For reasons of speed, cost, and efficiency, many DSP systems use fixed point mathematics. In these cases, much more care must be taken to properly handle potential numeric overflows and to minimize errors introduced by rounding and/or truncation. Overflow can often be avoided by rescaling results so that they cannot exceed the DSP word width during calculation. This safe-scaling sometimes is too confining, in which case the designer must specify the behavior when an overflow occurs. This might include clipping the signal, or allowing a two's compliment wraparound.

Another approach is to convert a high resolution result to a narrower word width. This occurs, for example, when calculations performed by the DSP are in a word width which is wider than the word width to be output, such as when 24-bit computations are performed but a 16-bit result is ultimately needed. In fixed-point computation, it is customary to scale and treat values as if they had a fixed decimal point. In the example given, 24-bit input values would be scaled to carry 8 fraction bits, leaving 16 bits for the signed integer portion of the value. While using such a fixed-point format adds accuracy to carefully planned calculations, a conversion must be performed when reducing the word width to a 16 bit integer value without the fractional bits to further computation or hardware. Two common approaches are used, truncation and rounding.

In truncation, the least significant N bits of the value are dropped, truncating to the lowest integer. Rounding adds 0.5 to the value and then truncates the result, rounding to the nearest integer.

Both these techniques have disadvantages. In signal processing terms, truncation introduces a biased error, a DC offset, into the result. Rounding also produces a biased error, although much smaller than truncation. Other techniques such as OR'ed rounding have been used to reduce this error bias. Rounding can be altered to remove its bias if certain assumptions about the statistics of the result are used.

All these techniques share a common characteristic; they are deterministic. That is, for a given high-resolution input value, the reduced width representation output will always be the same.

To analyze the performance of deterministic techniques, assumptions about the statistics of the signal being processed must be made. The most common assumption is that the lower significant bits of the signal are random. This allows the computation of an expected error bias. Considered as a time sequence, the rounding errors in such a case would be a white noise random sequence. Many textbooks and papers use this assumption to analyze the effects of rounding.

Unfortunately, few signal processing applications truly meet the criteria that the lower significant bits of each result are random. This is particularly true in applications where DSP techniques are used to generate a signal. In signal generation, the output sequence is generated parametrically from a noise-free data sequence. The consequence of these rounding techniques in such real-world applications of signal processing produce results that are not noise-like, but in fact can produce spurious responses which are signal related.

An approach is needed in producing reduced-width results which does not have the problems of known methods.

### SUMMARY OF THE INVENTION

Rounding operations in a digital signal processor are performed in a stochastic rather than a deterministic approach. A pseudo-random value is generated, and a preselected number of pseudo-random bits are added to the result to be rounded, prior to truncation being applied. Pseudo-random bits for the rounding operation may be generated by many means, including two maximal-length pseudo-random sequence generators.

### BRIEF DESCRIPTION OF THE DRAWINGS

The present invention is described with respect to particular exemplary embodiments thereof and reference is made to the drawings in which:

FIG. 1 shows the random rounding operation,

FIG. 2 shows an example of noise generation hardware, and

FIG. 3 shows an alternative embodiment of a portion of the noise generation hardware.

### DETAILED DESCRIPTION

When a fixed-point result in a DSP calculation must be reduced from a high precision to a reduced-width lower precision form, truncation and rounding have been the traditional approaches used. In truncation, the least significant N bits of the value are dropped, truncating to the lowest integer. Rounding adds 0.5 to the value, assuming the radix point at the rounding point, and then truncates the least significant N bits of the result, rounding to the nearest integer. Truncation introduces a bias error, a DC offset, into the result. Rounding also produces a biased error, although much smaller than truncation. Other techniques such as OR'ed rounding have been used to reduce this error bias. Rounding can be altered to remove its bias if certain assumptions about the statistics of the result are used.

These approaches are deterministic. That is, for a given high-resolution input value, the output, reduced width representation, will always be the same.

To analyze the performance of deterministic techniques, assumptions about the statistics of the signal being processed must be made. The most common assumption is that the lower significant bits of the signal are random. This allows the computation of an expected error bias. Considered as a time sequence, the rounding errors in such a case would be a white noise random sequence.

Unfortunately, few signal processing applications truly meet the criteria that the lower significant bits of each result are random. This is particularly true in applications where DSP techniques are used to generate a signal. In signal generation, the output sequence is generated parametrically from a noise-free data sequence. The consequence of errors introduced by these rounding techniques in such real-world applications of digital signal processing produce results that are not noiselike, but in fact can produce spurious responses which are signal related.

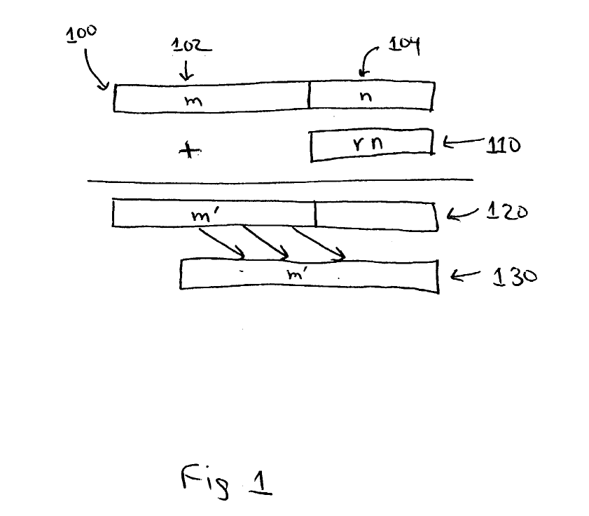

According to the present invention, a stochastic rather than a deterministic approach is used in rounding. Rather than adding the same value, 0.5, each time rounding is to be performed in the DSP, a random bit sequence corresponding to the n least significant bits is added in, and the result truncated. This is shown in FIG. 1. Value 100 is m 102 plus n 104 bits wide, and must be rounded to an m-bit result. Random n-bit value rn 110 is added to value 100 producing m+n bit result 120. The top m bits of result 120 are used as reduced-width result 130. In practice, the top m bits in reduced-width result 130 may be obtained by shifting result 120 to the right by n bits, or in hardware by simply gating out the required m bits. In the addition step, adding random n-bit value rn 110 to value 100, since the result will be truncated to the uppermost m bits, only the carry bit out of the lower n-bit sum is significant. This may be used to optimize the addition process by using known carry lookahead techniques.

Implementation of random rounding in a hardware based digital signal processing architecture with parallel rounding operations can require that a large number of independent noise bits be generated on each processing clock cycle. Without an efficient method of generating these bits, the whole idea of random rounding would be too complicated for practical implementation.

Truly random bits are hard to find. As stated by the renowned scientist John Von Neumann, “Anyone who considers arithmetical methods of producing random digits is, of course, living in a state of sin.” In practice, pseudo-random number generators are used. Their design has been studied at length. An overview of useful techniques is presented in Chapter 3, Random Numbers, in “The Art of Computer Programming, Volume 2, Seminumerical Algorithms” by Donald E. Knuth.

In the present invention, a large number of independent noise bits must be generated in a reasonably efficient manner. The generator used must have the property that its output when viewed as a time sequence produces a more or less uniform noise spectrum. In a hardware-based embodiment of the present invention, two linear feedback shift register generators are used. In a linear feedback shift register generator, a shift register of length k is used. Taps at specific points along the shift register are supplied to an exclusive-OR (XOR) or exclusive-NOR (XNOR) gate, the output of this gate used for the input to the shift register. When taps are selected properly, a generator of length or order k, where k is the highest bit number used in the feedback product, produces a sequence which repeats every 2^{k}−1 times. If the generator is implemented using a register of width m>k, the sequence of m-bit pseudo-random numbers will repeat every 2^{k}−1 times. A single linear feedback shift register generator does not have the noise spectrum desired for the present invention, as each successive result from such a generator is the previous result shifted one place and one bit added. Such a noise generator may be used for may purposes in digital signal processing, in addition to the use in stochastic rounding as presented herein.

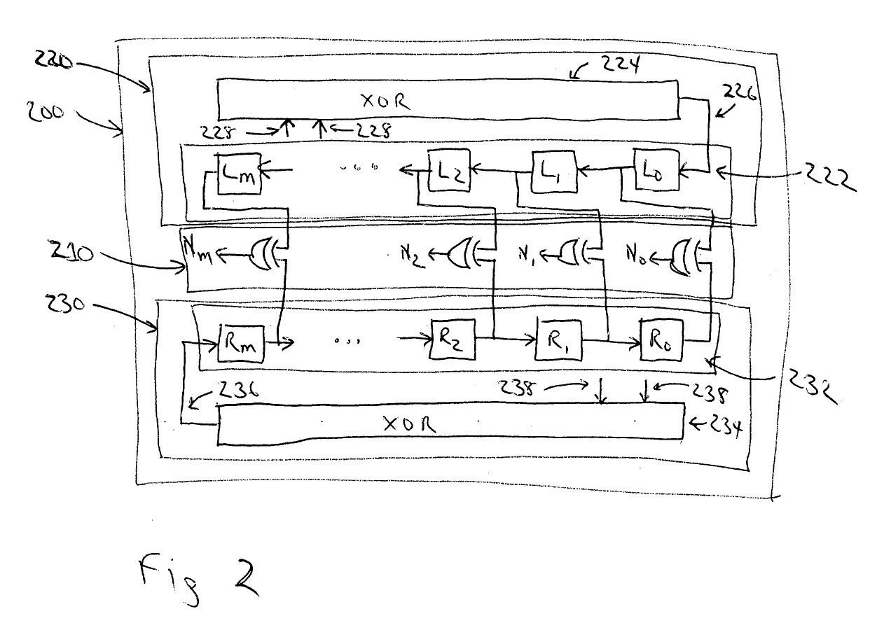

According to an embodiment of the present invention, two linear feedback shift register generators are used as shown in FIG. 2. Combined generator 200 produces output N 210 by XORing together the results of generators L 220 and R 230. Using the XNOR function rather than XOR produces equivalent results.

Generator L 220 comprises a shift register with bits 222 numbered 0 to m. Data is shifted from low bits to high, from L₀ to L₁. The input to shift register 222 at L₀ is generated by XOR tree 224 generating output 226 which is shifted into shift register 222. Inputs 228 to shift register tree 224 are bits tapped from specific stages in shift register 222. Replacing the XOR function with XNOR produces equivalent results.

Generator R 230 comprises a shift register with bits 232 numbered 0 to m. Data is shifted from high bits to low, from L1 to L0. The input to shift register 232 at Rₘ is generated by XOR tree 234 generating output 236 which is shifted into shift register 232. Inputs 238 to shift register tree 234 are bits tapped from specific stages in shift register 232. Replacing the XOR function with XNOR produces equivalent results.

Resulting output N is m+1 bits wide, with a new value produced every cycle. By choosing the individual lengths of shift registers L 220 as a and R 230 as b so that (2^{a}−1) and (2^{b}−1) are mutually prime, the overall period of sequences produced at N 210 is (2^{a}−1)(2^{b}−1).

In an embodiment where the registers are 32 bits wide (m=31), choosing the length a of shift register L 220 to be 28 and length b of shift register R 230 to be 29, a combined overall period of (2²⁹−1)(2²⁸−1) is obtained.

The selection of taps for maximal lengths is known to the art. For example, for a length a=28, the 28^{th} and 25^{th} bits of shift register L 222 are used. Since the bits are numbered starting with 0, these corresponds to bits 27 and 26 of shift register 222. Similarly, using a length b=29, the 29^{th} and 27^{th} bits of shift register R 232 are used. Counting this time from the high order bit (bit m) of shift register R 232, bits 3 and 4 of shift register 232 are used.

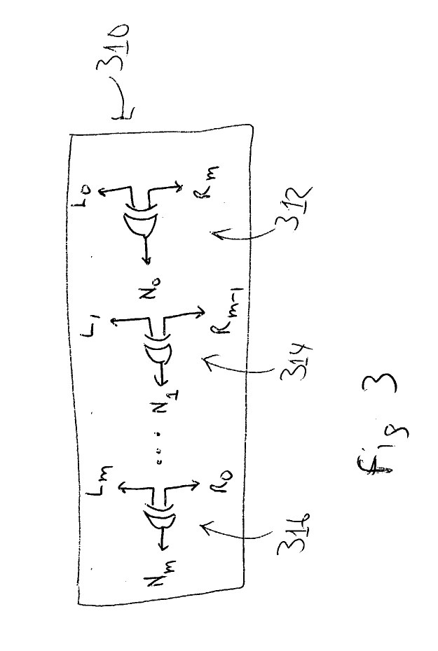

While this embodiment uses counter-rotating generators, it is possible to use two generators which rotate in the same direction, and achieve the same “counter-rotating” behavior through the connection of XOR block 210. For example, where FIG. 2 shows bit N₀ as the XOR of bits L₀ and R₀, FIG. 3 shows the XOR section 310 if two generators which rotate in the same direction are used. No would be the XOR 312 of L₀ and Rₘ, N₁ would be the XOR 314 of L₁ and Rₘ₋₁, and so on with Nₘ being the XOR 316 of Lₘ and R₀. An equivalent remapping of XOR block 220 would derive N₀ from the XOR of Lₘ and R₀, N₁ from the XOR of Lₘ₋₁ and R₁, and so on. Note that it does not matter which direction the shift registers shift, from low to high, or from high to low; it is the combination of their outputs which produces the required noise spectrum.

While it is possible to generate sequences of long lengths with a single, longer shift register, such a generator does not provide a large number of random (uncorrelated) bits on each clock cycle. When dealing with a single LFSR generator, the resulting noise words, taken as a time sequence, are simply one-sample delayed versions of the previous value, and not the desired “white” noise, which is obtained in the present invention by combining the output of two generators.

If implemented in software, a code-fragment in the C language for producing a 32-bit result similar to that produced by FIG. 2, using a=31 and b=29 is as follows:

unsigned long R, L;
unsigned long noise( ) {

L= ( (L>>27)&2) = = (L&2) ) ? (L, , 1) | 1:1<<1;
R= ( (R>>28)&1) = = (R&1) ) ? (R>>1) | 0x40000000:R>>1;
return L\hat{ }R;

}

In using the random bits so generated, a new set of random bits may be produced for each rounding operation to be performed, extracting only the number of bits needed for the operation. It may be possible to use one set of random bits for multiple rounding operations by selecting different groups of bits. For example, if 4 random bits are needed for a series of rounding operations, a 32-bit set of random bits may be divided into 8 4-bit groups.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. In a digital signal processor, the process of reducing a value from a first high precision fixed-point form to a second reduced-width lower precision form comprising:
calculating a random number,
adding a preselected number of bits of the random number to the value to form an intermediate result,
truncating the intermediate result producing a truncated value, and
returning the truncated value.

2. The process of claim 1a where the random number is generated by combining the outputs of a first pseudo-random sequence generator and a second pseudo-random sequence generator.

3. The process of claim 2 where the first and second pseudo-random sequence generators are linear feedback shift register generators.

4. The process of claim 3 where the period of the first pseudo-random sequence generator is relatively prime with respect to the period of the second pseudo-random sequence generator.

5. The process of claim 2 where the output of the first pseudo-random sequence generator is combined with the output of the second pseudo-sequence number generator using a bitwise exclusive or.

6. The process of claim 2 where the output of the first pseudo-random sequence generator is combined with the output of the second pseudo-random sequence generator using a bitwise exclusive nor.

7. The process of claim 3 where the first and second shift registers shift in opposite directions.

8. The process of claim 3 where the first and second shift registers shift in the same direction.

9. The process of claim 2 where the first and second pseudo-random sequence generators are implemented in hardware.

10. The process of claim 2 where the first and second pseudo-random sequence generators are implemented in software.

11. In a digital signal processor used in a signal generator, a noise generator for generating noise words, the noise generator comprising:
a first pseudo-random sequence generator,
a second pseudo-random sequence generator, and
a combiner for combining the outputs of the first and second pseudo-random sequence generators forming a noise word.

12. The noise generator of claim 11 where the first and second pseudo-random sequence generators comprise linear feedback shift register generators.

13. The noise generator of claim 11 where the combiner for combining the outputs of the first and second pseudo-random sequence generators is a bitwise exclusive or.

14. The noise generator of claim 11 where the combiner for combining the outputs of the first and second pseudo-random sequence generators is a bitwise exclusive nor.

15. The noise generator of claim 11 where the period of the first pseudo-random sequence generator is relatively prime with respect to the period of the second pseudo-random sequence generator.

16. The noise generator of claim 12 where the first and second linear feedback shift register generators shift in opposite directions.

17. The noise generator of claim 12 where the first and second linear feedback shift register generators shift in opposite directions.
